(19) United States
(12) Patent Application Publication
(10) Pub. No.: US 2008/0163730 A1
(43) Pub. Date: Jul. 10, 2008

(54) Adapter engaging structure

(76) Inventor: Terence Chen, Lugang Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/649,770

(22) Filed: Jan. 5, 2007

(51) Int. Cl. B25B 23/00

(52) U.S. Cl. 81/438

(57) ABSTRACT

An adapter engaging structure has an elastic pressing member on the surface of an adapter contacting with a driving head of a wrenching tool, the elastic pressing member is positioned inside the holding portion of the pressing member. With the engaging portion of the pressing member projecting slightly above the surface of the adapter, when the adapter is inserted into a driving portion of a tool, the projective engaging portion is engaged with the inner wall of the driving portion by means of an elastic engaging strength. In addition, when the pressing member is inserted into the holding portion, via the elastic pressing strength of the fixing portion of the pressing member to position the pressing member and the magnetic piece therein inside the holding portion, and without damaging the magnetic piece. Then the objectives of high stability and the engagement of the pressing member are attained.

### FIELD OF THE INVENTION

The present invention generally relates to adapters, and more particularly to an adapter engaging structure that is used for wrenching tools or pneumatic tools.

### BACKGROUND OF THE INVENTION

A conventional engaging or positioning structure of an adapter, such as TW Appl. No. 90202459, which uses different types of adapters for open-end or box-end socket wrenches, with which to apply to different sizes of bolts or nuts. The socket adapter is provided with magnetic device, which uses the magnetism of the magnet to attract with the inner wall of the socket for positioning. Such structure has shortcomings on installation and positioning, which are:

1. The magnetic device is not easy to be fixed with the adapter: the magnetic device is in the shape of a plate, which is brittle and not easy to be fixed in position. Most of the magnetic device and the adapter are connected together with glue that is easy to degum when touching water, and on the process of gluing the magnetic device and the adapter need to be cleaned. If there is dust or oil thereon, the magnetic device is unable to be attached with the adapter and easy to come off.

2. The effect of fixing is not optimum: the magnetic device connects with the inner wall of the socket with the magnetism, so that if there is magnetism interference on the work place or the magnetic device loses its magnetism, which is hard to produce the effect of magnetizing, or the component of the socket is not made of magnetic material, which cannot be used for this type of adapter.

### SUMMARY OF THE INVENTION

The primary objective of the present invention is to provide an adapter engaging structure, wherein the adapter is equipped with an elastic pressing member, with the engaging portion of the pressing member projecting above the surface of the pressing member, the engaging portion can be engaged with the inner wall of the driving portion of a tool by means of elastic deformation thereof, so that the objective of tight elastic engagement is attained.

The other objective of the present invention is to provide an adapter engaging structure, wherein the adapter is equipped with an elastic pressing member, with the fixing portion of the pressing member inserting into the holding portion of the adapter, the fixing portion can be engaged with the inner wall of the holding portion of the adapter by means of elastic deformation thereof, which can increase the fixing strength of the pressing member, in addition, the magnetic piece is provided inside thereof to increase the stability of fixing, so that the objective of tight elastic engagement is attained.

The present invention will become more obvious from the following description when taken in connection with the accompanying drawings that show, for purposes of illustration only, a preferred embodiment in accordance with the present invention.

### BRIEF DESCRIPTION OF THE DRAWINGS

FIG. 1 is an exploded view of the of the present invention;

FIG. 2 is a perspective view of the of the present invention;

FIG. 3 is a top plan view showing the assembly of the present invention;

FIG. 4-1 is a top plan view showing the adapter of the present invention engaging with a driving portion of a tool;

FIG. 4-2 is a top plan view showing the adapter of the present invention engaging with a driving portion of a tool;

FIG. 5 is a cross-sectional view of the pressing member according to the second embodiment of the present invention;

FIG. 6 is an exploded view of the pressing member according to the third embodiment of the present invention;

FIG. 7 is an exploded view of the pressing member according to the fourth embodiment of the present invention;

FIG. 8 is an exploded view of the pressing member according to the fifth embodiment of the present invention; and

FIG. 9 is a top plan view according to the sixth embodiment of the present invention.

### DETAILED DESCRIPTION OF THE PREFERRED EMBODIMENT

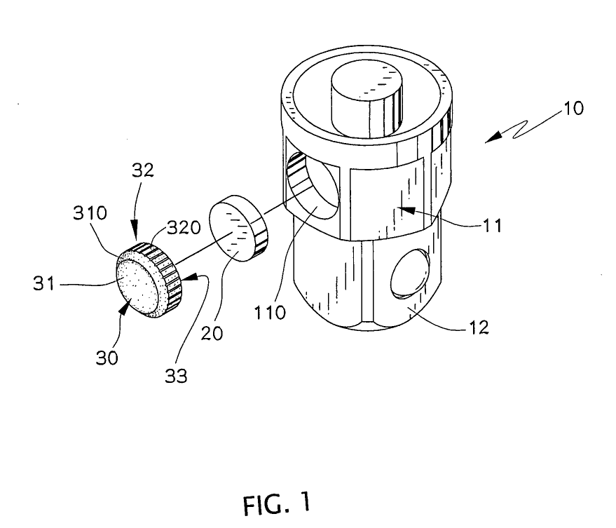

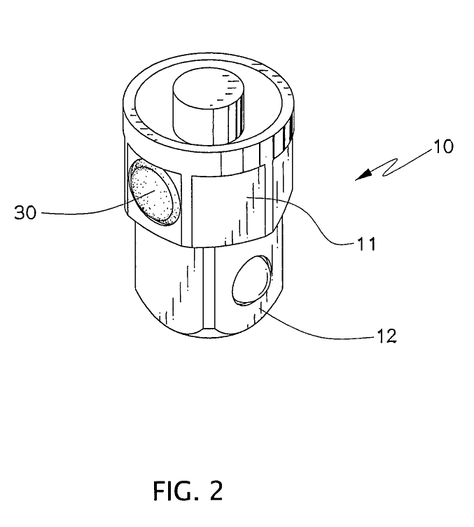

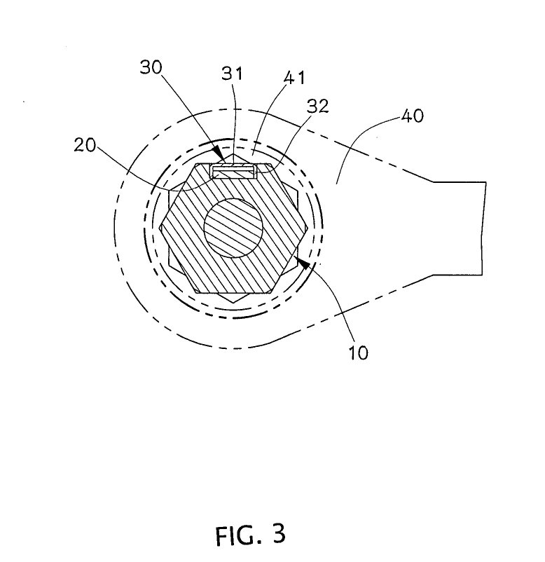

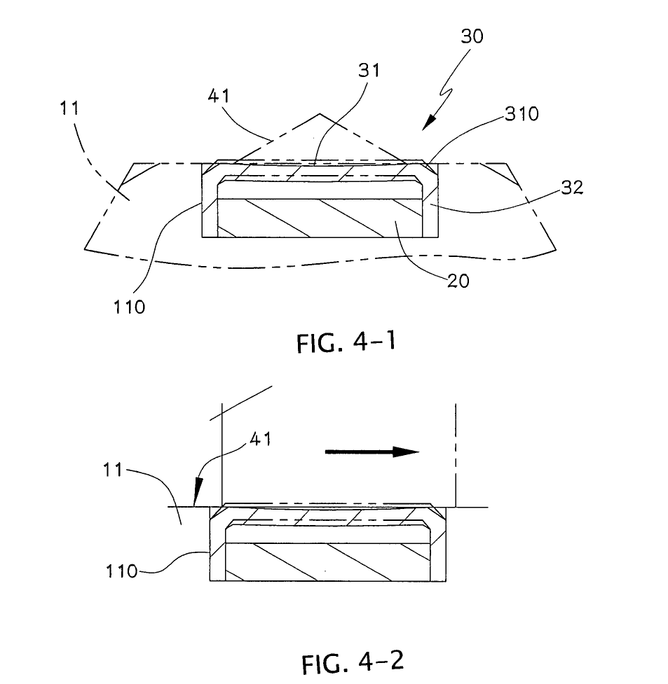

Referring to FIGS. 1 to 4-2, an adapter 10 of the present invention is a universal hexagon-tetragon adapter, which includes a large hexagonal position portion 11 that has a recess holding portion 110 for accommodating a magnetic piece 20, and a small tetragonal driven portion 12 projecting outwardly to one side of the adapter 10 for receiving a fastener or a socket.

The holding portion 110 of the adapter 10 receives an elastic pressing member 30 that is pressed with an elastic plate into a concave structure. The pressing member 30 includes an engaging portion 31 projecting out of the holding portion 110 of the adapter 10, a sloping guiding portion 310 provided on the periphery of the engaging portion 31, a fixing portion 32 extending from the guiding portion 310 and a concave accommodating portion 33 formed on the inner surface of the fixing portion 32 for accommodating the magnetic piece 20. A pattern of detent 320 is formed on the outer surface of the fixing portion 32 to engage with the wall of the holding portion 110. The pressing member 30 has an elastic deformable space formed inside the engaging portion 31 for the engaging portion 31 and the guiding portion 310 to deform elastically.

The pressing member 30 is engaged with the holding portion 110 by pressing the fixing portion 32 into the holding portion 110 to form an elastic fixing structure, and then the magnetic piece 20 inside the accommodating portion 33 will be fixed rigidly, without damaging the magnetic piece 20 and the objective of fixing of the magnetic piece 20 and the pressing member 30 is attained. The engaging portion 31 of the pressing member 30 projects slightly above the surface of the position portion 11, as shown in FIGS. 4-1 and 4-2, when the engaging portion 31 of the adapter 10 is in a driving portion 41 of a tool 40, the inner corner of the driving portion 41 presses the engaging portion 31 of the pressing member 30, and via the guiding portion 310 guiding and engaging elastically, the engaging portion 31 is contacted with the inner corner of the driving portion 41 tightly, and then the objectives of firm engagement and elastic positioning of whole structure are attained.

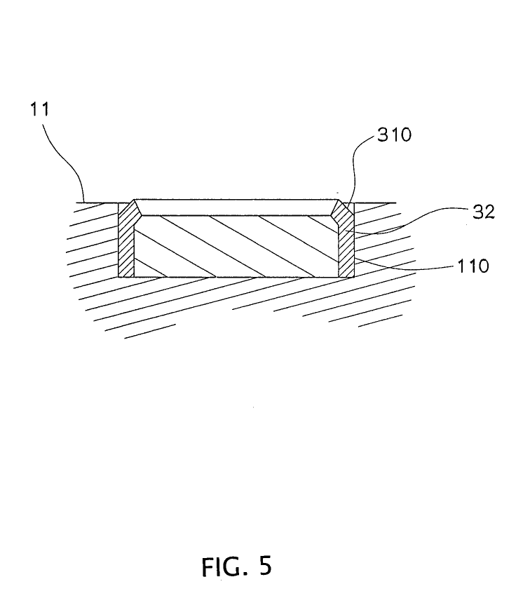

Referring to FIG. 5, the pressing member 30 on the adapter 10 is not provided with the engaging portion 31, therefore the guiding portion 310 is extended slantwise directly from the fixing portion 32. The guiding portion 310 guides and engages with the driving portion 41 directly, in addition the magnetic piece 20 attracts therewith.

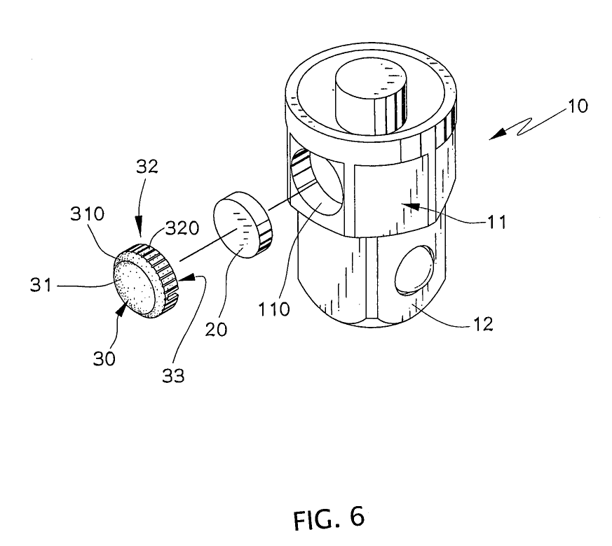

Referring to FIG. 6, the fixing portion 32 of the pressing member 30 is provided with an elastic gap 321 to increase the elasticity range of the fixing portion 32 for the elastic deformation of the fixing portion 32 pressing into the adapter 10, so that the objective of exact fixing is attained.

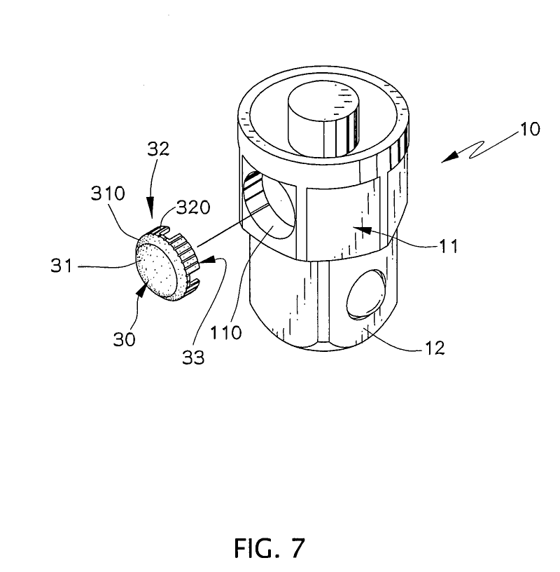

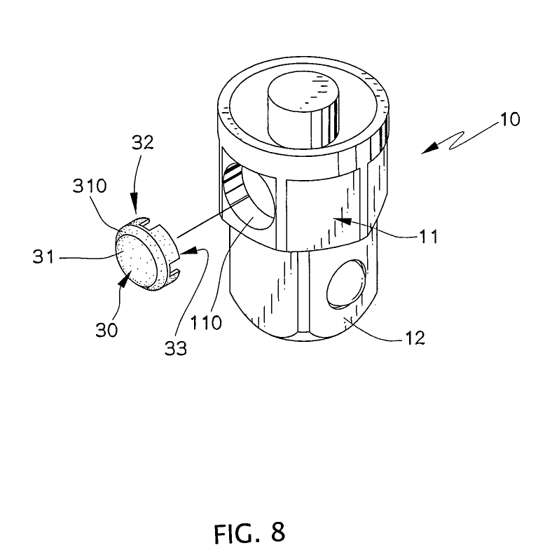

The magnetic piece 20 can be installed inside the pressing member 30 as shown in FIGS. 1 to 6, or the pressing member 30 can be inserted directly into the holding portion 110 of the adapter 10 without the magnetic piece 20 as shown in FIG. 7, wherein the fixing portion 32 of the pressing member 30 is provided with several gaps 321. The fixing portion 32 is designed without patterns, as shown in FIG. 8, and the fixing portion 32 can be still fixed inside the holding portion 110 of the adapter 10.

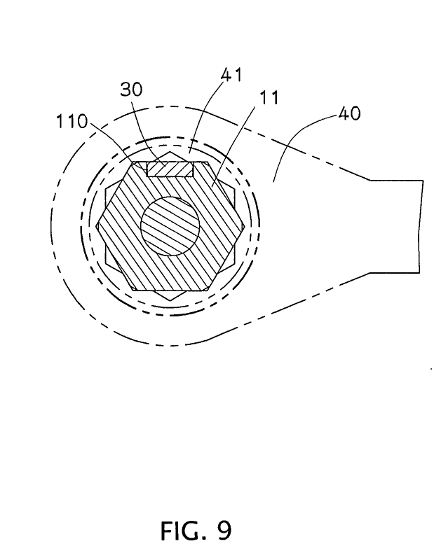

The pressing member 30 may be made of a soft metal material such as copper or aluminum, with the character of the material to provide the range of deformation, or a material that is the same with the adapter 10 or the driving portion 41 of the tool 40, with the elasticity of the material to provide the strength of deforming engagement and fixing. The pressing member 30 may be made of urethane, as shown in FIG. 9, which is a solid elastic structure.

While we have shown and described the embodiment in accordance with the present invention, it should be clear to those skilled in the art that further embodiments may be made without departing from the scope of the present invention.

1. An adapter engaging structure comprising:
an adapter including a position portion having a holding portion, and a driven portion projecting outwardly to one side of side adapter; and
a pressing member that is provided in said holding portion of said adapter and includes an engaging portion, which is elastic and adapted for being pressed, projecting out of said holding portion of said adapter projecting out of said holding portion, a fixing portion provided on the periphery of said engaging portion, and an accommodating portion formed on the inner surfaced of said fixing portion;
wherein a magnetic piece is received in said accommodating portion of said pressing member.

2. The adapter engaging structure as claimed in claim 1, with a sloping guiding portion provided on the periphery of said engaging portion, with said fixing portion extending from said sloping guiding portion.

3. The adapter engaging structure as claimed in claim 1, wherein a pattern of detent is formed on the outer surface of said fixing portion of said pressing member.

4. The adapter engaging structure as claimed in claim 1, wherein said fixing portion of said pressing member is provided with at least one gap.

5. (canceled)

6. The adapter engaging structure as claimed in claim 1, wherein said pressing member being a solid elastic structure.

7. The adapter engaging structure as claimed in claim 6, wherein said pressing member is made of urethane.

8. An adapter engaging structure comprising:
an adapter including a position portion having a holding portion, and a driven portion projecting outwardly to one side of said adapter;
a pressing member, which is elastic and provided in said holding portion of said adapter, including a fixing portion toward said holding portion and an accommodating portion formed on inner surface of said fixing portion;
wherein a magnetic piece is received in said accommodating portion of said pressing member.

9. The adapter engaging structure as claimed in claim 8, wherein said pressing member further includes a sloping guiding portion, and said fixing portion extending from said sloping guiding portion.

10. The adapter engaging structure as claimed in claim 8, wherein a pattern of detent is formed on the outer surface of said fixing portion of said pressing member.

11. The adapter engaging structure as claimed in claim 8, wherein said fixing portion of said pressing member is provided with at least one gap.

12. (canceled)

13. The adapter engaging structure as claimed in claim 8, wherein said pressing member being a solid elastic structure.

14. The adapter engaging structure as claimed in claim 13 wherein said pressing member is made of urethane.

15. An adapter engaging structure comprising:
an adapter including a position portion having a holding portion, and a driven portion projecting outwardly to one side thereof;
a pressing member having an engaging portion projecting slightly out of said holding portion, said pressing member having a deformable space inside thereof for said engaging portion, a sloping guiding portion provided on the periphery of said engaging portion, a fixing portion extending from said guiding portion, and an accommodating portion formed on the inner surface of said fixing portion.

16. (canceled)

17. The adapter engaging structure as claimed in claim 15, wherein a pattern of detent is formed on the outer surface of said fixing portion of said pressing member.

18. The adapter engaging structure as claimed in claim 15, wherein said fixing portion of said pressing member is provided with at least one gap.
